(19) United States
(12) Patent Application Publication
(10) Pub. No.: US 2010/0193647 A1
(43) Pub. Date: Aug. 5, 2010

(54) SUPPORT

(75) Inventors: HSIEN-HUEI HUANG, ZHONGHE CITY (TW); CHING-HUI YEN, ZHONGHE CITY (TW)

Correspondence Address: KILE GOEKJIAN REED & MCMANUS, 1200 NEW HAMPSHIRE AVE, NW, SUITE 570, WASHINGTON, DC, 20036, US

(73) Assignee: SYNCMOLD ENTERPRISE CORP.

(21) Appl. No.: 12/684,198

(22) Filed: Jan. 8, 2010

(30) Foreign Application Priority Data
Feb. 4, 2009 (TW) 98201656

(51) Int. Cl. F16M 11/00; F16M 13/02; F16M 11/08; F16M 11/24

(52) U.S. Cl. 248/124.1

(57) ABSTRACT

A support includes a base seat, a sustaining housing, a swing module, a horizontal-driving module and a vertical-driving module. The base seat has a bottom plate and a rotated plate disposed on the bottom plate. The sustaining housing is assembled on the rotated plate. The swing module is mounted on the sustaining housing. The horizontal-driving module includes a horizontal driving unit which is received in the sustaining housing and connected to the rotated plate. The vertical-driving module includes a vertical-driving unit which is received in the sustaining housing and connected to the swing module. An LCD mounted on the swing module can be adjusted easily to a best view angle by electrically driven the support.

### BACKGROUND OF THE INVENTION

1. Field of the Invention

The present invention is related to a support for supporting an LCD (liquid crystal display) monitor and adjusting the view angle or position of the LCD.

2. Description of Related Art

There is an inevitable trend that the LCD (liquid crystal display) replaces gradually the traditional CRT (Cathode Ray Tube) monitor. With the gradual improvement of manufacturing technology, the screen size of the LCD becomes larger and larger, which follows a heavier issue of the LCD.

Furthermore, the visual angle of the LCD is still limited caused users can not watch well at any angle, even if it is thin and light and occupies smaller space. The user therefore must apply a certain amount of force for adjusting the angle of the LCD.

The LCD is usually mounted to a support, and the user must apply a force to move the support and adjust the LCD to a proper view angle. Such a manual adjustment is strenuous and time-consuming, and it is hard to adjust preciously to a best view angle.

The conventional support for the LCD, moreover, only can be adjusted along the vertical direction. To adjust the view angle on the horizontal plane usually needs to move and turn the support wholly, which is very inconvenient.

In view of the aforementioned issues, the present invention provides a support for an LCD to mitigate and/or obviate the aforementioned problems.

### SUMMARY OF THE INVENTION

It is the main objective of the present invention to provide a support, which can adjust an LCD having rotating or swinging action along a horizontal and a vertical directions by electrically driven, thus the LCD can be easily adjusted to an best view and the process of adjusting is time-saving and easy-to-maneuver.

According to one aspect of the present invention, the support includes a base seat, a sustaining housing, a swing module, a horizontal-driving module and a vertical-driving module. The base seat has a bottom plate and a rotated plate disposed on the bottom plate. The sustaining housing is assembled on the rotated plate. The swing module is assembled on the sustaining housing. The horizontal-driving module has a horizontal-driving unit, which is received in the sustaining housing and connected to the rotated plate. The vertical-driving module has vertical-driving unit which is received in the sustaining housing and connected to the swing module.

The present invention thereby has the benefit results as following. User can electrically drive the horizontal-driving unit and the vertical-driving unit to rotate and swing the LCD, therefore the LCD can be easily adjusted to a desired angle, and the process of adjusting is time-saving and easy-to-maneuver.

Furthermore, by the horizontal-driving module and the vertical-driving module, the present invention can make the LCD to rotate or swing along the horizontal or vertical direction. User can perform omni-directional adjustment more accurately.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

FIG. 1 is a perspective exploded view according to the present invention;

FIG. 2 is another perspective exploded view of a support according to the present invention;

FIG. 3 is a perspective assembled view of a support according to the present invention;

FIG. 4 is a partial perspective assembled view of a support according to the present invention;

FIG. 5 is a side-sectional view of a support according to the present invention to show a swing;

FIG. 6 is a top view of a support according to the present invention;

FIG. 7 is a perspective view of a support according to the present invention to show a rotation; and

FIG. 8 is a perspective view of a support according to the present invention assembled with an LCD.

### DETAILED DESCRIPTION OF THE PREFERRED EMBODIMENTS

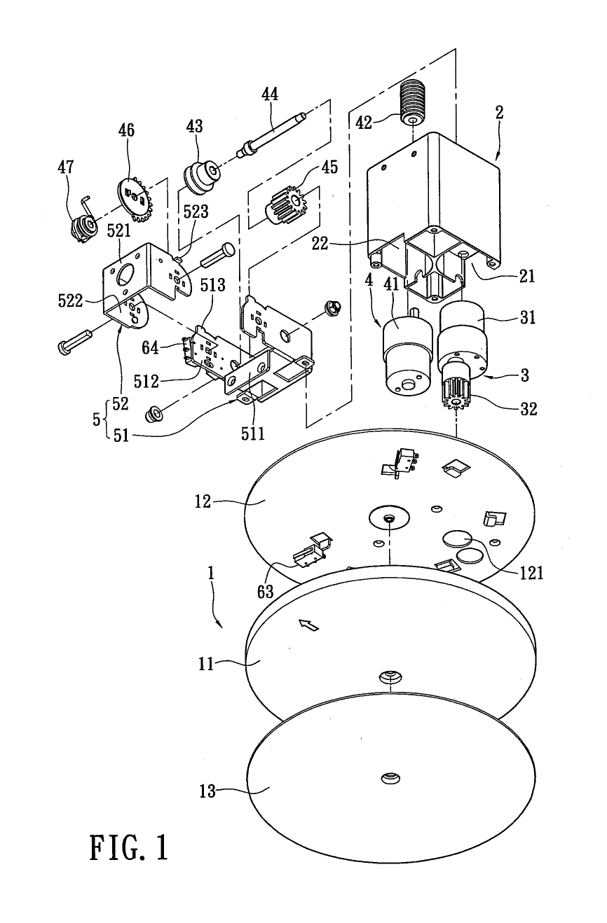

Referring to FIGS. 1-8, a support in accordance with the invention is composed of a base seat 1, a sustaining housing 2, a horizontal-driving module 3, a vertical-driving module 4 and a swing module 5.

Referring to FIGS. 1-3, the base seat 1 has a bottom plate 11 and a rotated plate 12 pivotally mounted on the bottom plate 11. The bottom plate 11 and the rotated plate 12 are circle plates matched to each other. The rotated plate 12 has a through hole 121. The through hole 121 is formed through and located at an off-centre position of the rotated plate 12.

The sustaining housing 2 is a hollow sustaining structure. In this embodiment, the sustaining housing 2 is a tube-shaped cube, and is partitioned into a first chamber 21 and a second chamber 22. The first chamber 21 and the second chamber 22 are used to receive a horizontal-driving unit 31 of the horizontal-driving module 3 and a vertical-driving unit 41 of the vertical-driving module 4, respectively. The first chamber 21 is correspondingly formed above the through hole 121 of the rotated plate 12 and communicated therewith.

The swing module 5 has an affixing bracket 51 and a swing bracket 52 pivotally connected to the affixing bracket 51. The affixing bracket 51 has a fixed wall 511, two first-pivoting walls 512 and two blocking lugs 513. The fixed wall 511 is fixed on the top end of the sustaining housing 2. The two first-pivoting walls 512 are upwardly extended from two sides of the fixed wall 511, respectively. The blocking lug 513 is protruded from an edge of the first-pivoting wall 512.

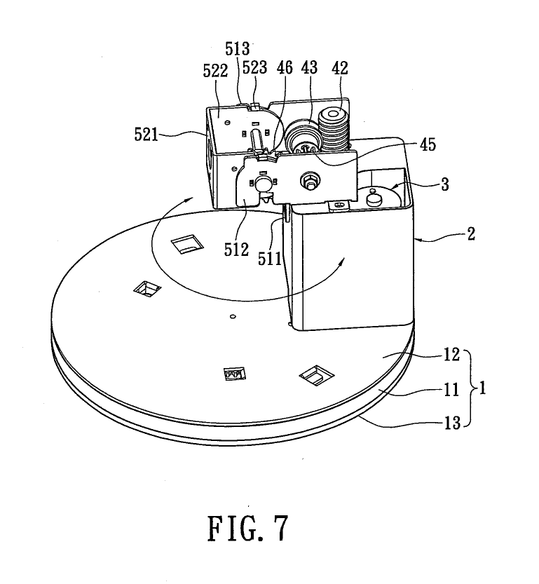

The swing bracket 52 has a retaining wall 521, two second-pivoting walls 522 and two restricting lugs 523. The retaining wall 521 is connected with an LCD 7 (as shown in FIG. 7), and it can swing upwardly or downwardly by the action of the vertical-driving module 4. The two second-pivoting walls 522 are respectively extended from two sides of the retaining wall 521, and are pivotally connected to the inside surface of the two first-pivoting walls 512. The restricting lugs 523 are protruded from an edge of the second-pivoting walls 522, respectively. When the second-pivoting walls 522 rotate to a predestinated angel relative to the first-pivoting walls 512, the restricting lugs 523 are stopped by the blocking lug 513. Thus, the swing range of the swing bracket 52 would be limited, so that the swing range will not too wide to damage the support and the LCD retained thereon.

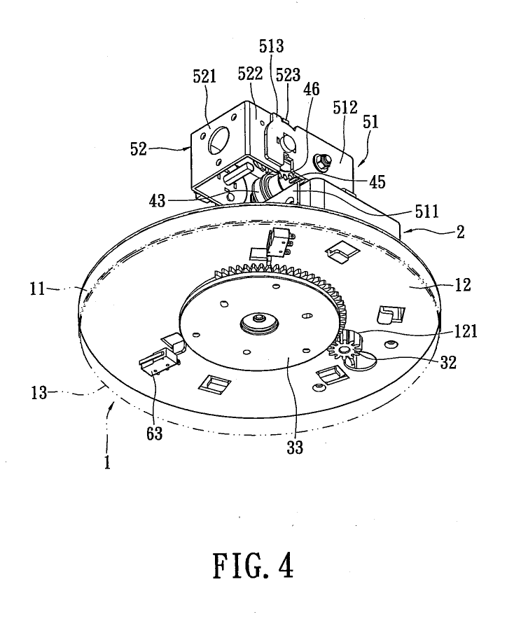

The horizontal-driving module 3 includes a horizontal-driving unit 31, a horizontal-actuating gear 32 and a horizontal-fixed gear 33. The horizontal-driving unit 31 is a drive motor in this embodiment, which is received in the first chamber 21 of the sustaining housing 2. The horizontal-actuating gear 32 is connected to the horizontal-driving unit 31 and is driven by the power of the horizontal-driving unit 31 to achieve a rotating action. The horizontal-fixed gear 33 is fixed on the bottom plate 11. The horizontal-actuating gear 32 penetrates through the through hole 121 of the rotated plate 12 and is engaged with the teeth formed on the edge of the horizontal-fixed gear 33 (as shown in FIG. 4). The horizontal-driving unit 31 and the horizontal-actuating gear 32 together revolve around the center of the horizontal-fixed gear 33.

When the horizontal-driving unit 31 and the horizontal-actuating gear 32 revolved round the horizontal-fixed gear 33, the sustaining housing 2 is driven simultaneously and the LCD 7 retained thereon can be rotated (as shown in FIG. 7).

Referring to FIGS. 1-3 and 6, the vertical-driving module 4 includes a vertical-driving unit 41, a vertical-actuating member 42, a first vertical-driven member 43, a transmitting rod 44, a second vertical-driven member 45, a vertical fixed gear 46 and an elastic member 47.

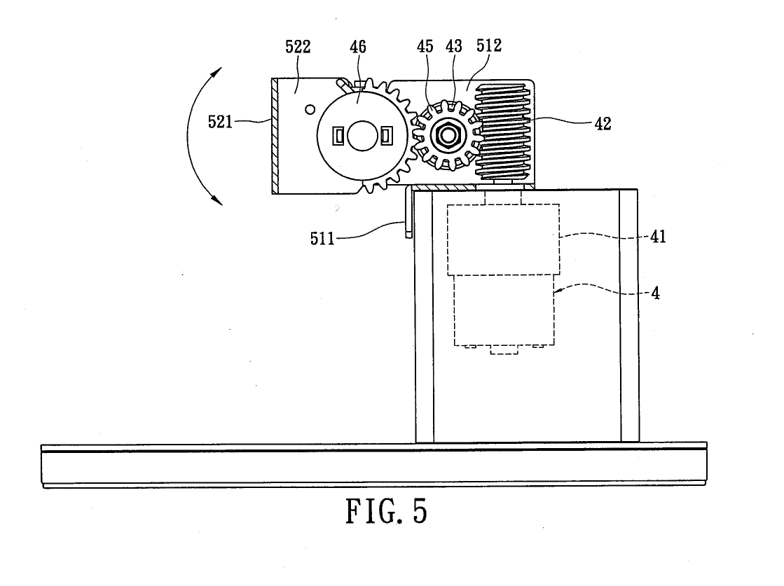

The vertical-driving unit 41 is a drive motor in this embodiment, which is received in the second chamber 122 of the sustaining housing 12 and is close to the horizontal-driving unit 31. The vertical-actuating member 42 is a worm (perpetual screw), which is driven by the vertical-driving unit 41. The transmitting rod 44 passes through the two first-pivoting walls 512 of the affixing bracket 51. The first vertical-driven member 43 and the second vertical-driven member 45 are pivotally assembled at two ends of the transmitting rod 44, respectively. The first vertical-driven member 43 is a worm gear, which is engaged with the vertical-actuating member 42 (worm). The second vertical-driven member 45 is a pivotal gear, which is engaged with the vertical fixed gear 46 for transferring an action (as shown in FIG. 5).

The elastic member 47 is a torsional spring for providing a torsion, which is pressed against the vertical fixed gear 46 via a adjustable bolt (not labelled). The vertical fixed gear 46 is against the second-pivoting walls 522. Therefore, a sufficient friction is provided between the vertical fixed gear 46 and the second-pivoting wall 522, and the swing bracket 52 can be driven. It also makes a friction between the first-pivoting wall 512 and the second-pivoting walls 522. In this embodiment, there is one elastic member 47, however it would be a pair of elastic members 47 assembled on two sides of the swing bracket 52, if necessary. According the weight of the monitor, the friction between the first-pivoting wall. 512 and the second-pivoting walls 522 is adjustable by the adjustable bolt. Furthermore, a washer would be placed between the first-pivoting wall 512 and the second-pivoting walls 522.

Referring to FIGS. 1-3, the present invention further includes a control unit 6, which can control the horizontal-driving module 3 and the vertical-driving module 4 to act expected motions of rotation or swing. The control unit 6 includes a remote 61, a receiver 62, a horizontal-limit switch 63 and a vertical-limit switch 64.

The receiver 62 can receive the remote signal from the remote 61, which can be positioned in the base seat 1 or the sustaining housing 2 at any proper location thereof. The receiver 62 is electrically connected to the horizontal-driving unit 31 and the vertical-driving unit 41. User therefore can use the remote 61 to control wirelessly the horizontal-driving unit 31 and the vertical-driving unit 41, and enable the sustaining housing 2 and the swing module 5 to achieve expected rotation or swing motions.

The horizontal-limit switch 63 and the vertical-limit switch 64 are disposed on the base seat 1 and the affixing bracket 51, respectively. When the sustaining housing 2 and the swing module 5 move to an predestinated angle, the horizontal-limit switch 63 and the vertical-limit switch 64 will sense and cause the horizontal-driving unit 31 and the vertical-driving unit 41 to stop. The rotation angle of the sustaining housing 2 and the swing angle of the swing module 5 can be limited therefore, to avoid rotating beyond an expected position damaged the LCD 7.

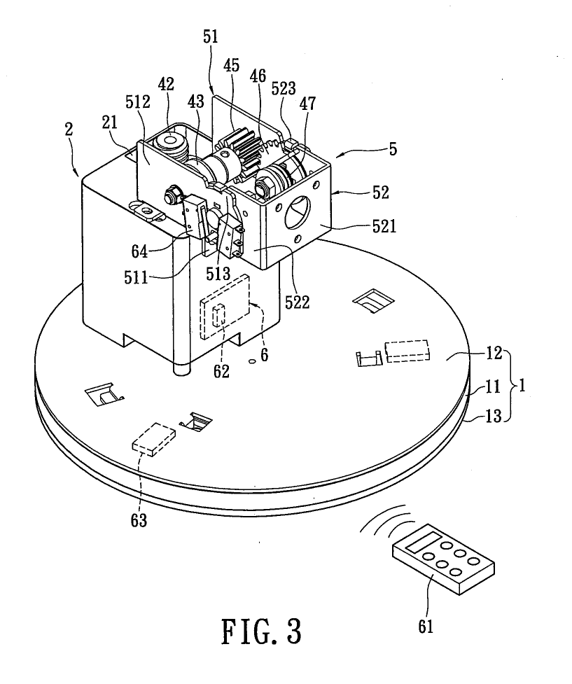

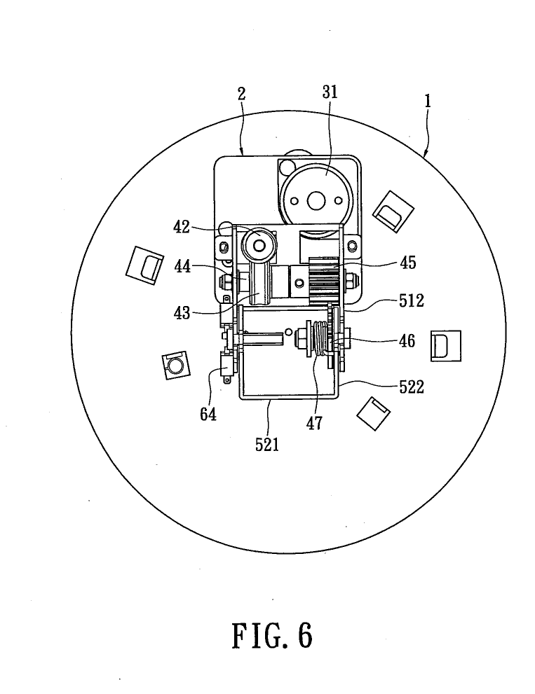

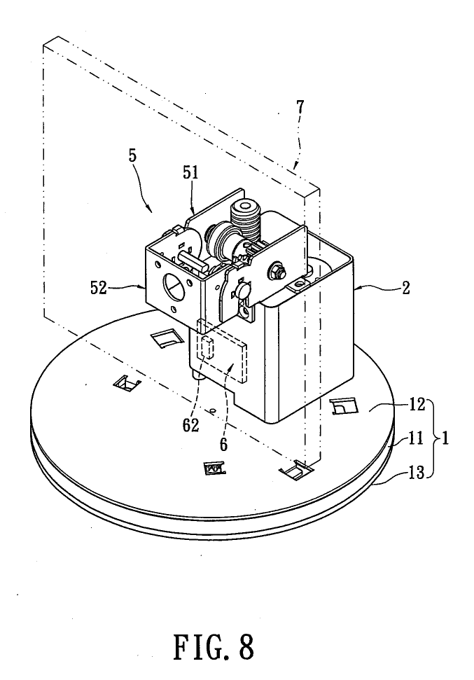

Referring to FIGS. 6 and 8, there is one thing in the present invention worthy to be specifically mentioned that, besides using the remote 61, user also can manually apply a force on the swing bracket 52 to control the swing bracket 52. When the applied force by user is greater than the friction between the first-pivoting wall 512 and the second-pivoting walls 522, the swing bracket 52 would be forced to rotate to achieve the purpose of adjusting the LCD 7. This function allowed the user to still be able to adjust the LCD, when the control unit 6 (as shown FIG. 3) is malfunctioned or is not available.

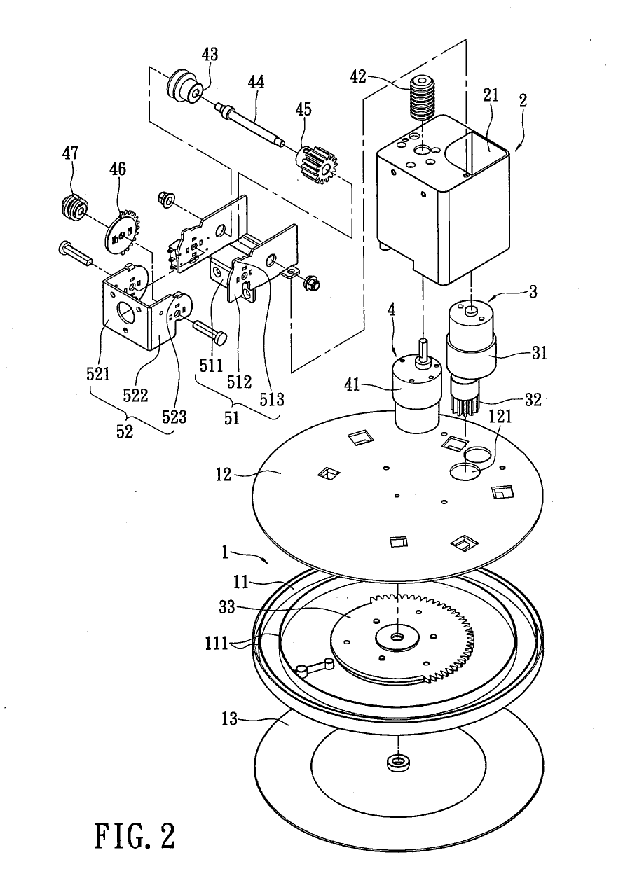

Referring to FIGS. 1-2, the present invention further includes a fixed platform 13. The bottom plate 11 could be disposed on a desktop, and it also can be pivotally disposed on the fixed platform 13. The bottom plate 11 has at least one ring 111. The ring 111 is a ring-shaped protrusion, which encircled outside the horizontal-fixed gear 33. The bottom plate 11 and the fixed platform 13 are contacted surface by surface. The ring 111 of the bottom plate 11 and a bottom surface of the rotated plate 12 are contacted in a line way. In other words, the friction between the bottom plate 11 and the fixed platform 13 is greater than the friction between the ring 111 of the bottom plate 11 and the rotated plate 12.

Therefore, when the horizontal-driving unit 31 drives the horizontal-actuating gear 32 to cause the horizontal-fixed gear 33 to rotate, the horizontal-actuating gear 32 only will urge the rotated plate 12 to rotate on the bottom plate 11. Because the horizontal-fixed gear 33 is fixed on the bottom plate 11 and the friction between the bottom plate 11 and the fixed platform 13 is greater, the force will not urge the bottom plate 11 to rotate on the fixed platform 13 simultaneously.

Similarly, when user want to urge the sustaining housing 2 to rotate in manual way, a physical strength can be forced on the sustaining housing 2. Since the horizontal-actuating gear 32 and the horizontal-fixed gear 33 are engaged deadly, the rotated plate 12 will not rotate on the bottom plate 11. When the physical strength is larger than the friction between the bottom plate 11 and the fixed platform 13, the bottom plate 11 and the rotated plate 12 with the sustaining housing 2 mounted thereon would rotate together.

The following are some advantages of the support of the present invention for supporting an LCD screen:

1. The present invention would allow user to control the rotation of LCD 7 in electric way, thus the LCD 7 can be adjusted to a proper view angle and the process is time-saving and easy-to-maneuver.

2. Furthermore, by the horizontal-driving module 3 and the vertical-driving module 4, the present invention can make the LCD 7 to rotate or swing along the horizontal or vertical direction. User can perform omni-directional adjustment more accurately.

3. User can drive the horizontal-driving module 3 and the vertical-driving module 4 by the remote 61 to adjust view angle, which is provide an unconstrained operating feeling.

4. Besides the electric driving way, user also can rotate manually the sustaining housing 2 and the swing bracket 52 without electricity power.

The above-mentioned descriptions merely represent solely the preferred embodiments of the present invention, without any intention or ability to limit the scope of the present invention which is fully described only within the following claims. Various equivalent changes, alterations or modifications based on the claims of present invention are all, consequently, viewed as being embraced by the scope of the present invention.

What is claimed is:

1. A support comprising:
a base seat, having a bottom plate and a rotated plate disposed on the bottom plate;
a sustaining housing, assembled on the rotated plate;
a swing module, assembled on the sustaining housing;
a horizontal-driving module, having a horizontal-driving unit, the horizontal-driving unit being received in the sustaining housing and connected to the rotated plate; and
a vertical-driving module, having a vertical-driving unit, the vertical-driving unit being received in the sustaining housing and connected to the swing module.

2. The support as claimed in claim 1, wherein the horizontal-driving module includes a horizontal-actuating gear and a horizontal-fixed gear, the horizontal-actuating gear connected to the horizontal-driving unit, the horizontal-fixed gear mounted on the bottom plate, and the rotated plate is pivotally connected to the horizontal-fixed gear, and wherein the rotated plate has a through hole formed through and located at an off-centre position thereof, the horizontal-actuating gear penetrated the through hole and engaged with the horizontal-fixed gear.

3. The support as claimed in claim 2, wherein the vertical-driving module includes a vertical-actuating member and a vertical fixed gear, the swing module having a affixing bracket and a swing bracket pivotally connected to the affixing bracket, the vertical fixed gear fixed on the swing bracket, the vertical-actuating member connected with the vertical fixed gear.

4. The support as claimed in claim 3, wherein the affixing bracket includes a fixed wall and two first-pivoting walls extended from two sides of the fixed wall, and wherein the swing bracket includes a retaining wall and two second-pivoting walls extended from two sides of the retaining wall, the second-pivoting wall pivotally connected to the first-pivoting wall, the vertical fixed gear fixed on the second-pivoting wall.

5. The support as claimed in claim 4, wherein the vertical-driving module includes a first vertical-driven member, a transmitting rod and a second vertical-driven member, the transmitting rod passed through two first-pivoting walls of the affixing bracket, the first vertical-driven member and the second vertical-driven member respectively located on two ends of the transmitting rod, and pivotally connected to the two first-pivoting walls, the second vertical-driven member connected to the vertical fixed gear.

6. The support as claimed in claim 5, wherein the vertical-driving module includes an elastic member, the elastic member propped up the vertical fixed gear against the second-pivoting wall.

7. The support as claimed in claim 4, wherein the first-pivoting wall is formed with a blocking lug on an edge thereof, the second-pivoting wall is formed with a restricting lug on an edge thereof, the restricting lug is stopped by the blocking lug.

8. The support as claimed in claim 1, further comprising a control unit, the control unit electrically connected to the horizontal-driving unit and the vertical-driving unit.

9. The support as claimed in claim 8, wherein the control unit includes a remote and a receiver, the receiver electrically connected to the horizontal-driving unit and the vertical-driving unit and receiving a single out from the remote.

10. The support as claimed in claim 9, wherein the control unit includes a horizontal-limit switch and a vertical-limit switch, and wherein the horizontal-limit switch and the vertical-limit switch electrically connected to the horizontal-driving unit and the vertical-driving unit, respectively.

11. The support as claimed in claim 2, further comprising a fixed platform, the bottom plate pivotally assembled on the fixed platform, the bottom plate has at least one ring, the ring circled the horizontal-fixed gear and contacted with the rotated plate, a friction between the bottom plate and the fixed platform being larger than that of between the ring and the rotated plate.
